(19) United States
(12) Patent Application Publication
(10) Pub. No.: US 2026/0086049 A1
(43) Pub. Date: Mar. 26, 2026

(54) X-RAY MEASURMENT SYSTEM AND COMPOSITE SEMICONDUCTOR INSPECTION SYSTEM

(71) Applicant: NanoSeex Inc., Hsinchu County (TW)

(72) Inventors: YU-YAN AU YONG, Hsinchu County (TW); CHIA-YU LIN, Hsinchu County (TW); TSUNG-HSIEN HAN, Hsinchu County (TW); CHUN-TING LIU, Hsinchu County (TW); PO-CHING HE, Hsinchu County (TW); PO-TSANG WU, Hsinchu County (TW)

(21) Appl. No.: 19/010,199

(22) Filed: Jan. 6, 2025

(30) Foreign Application Priority Data
Sep. 25, 2024 (TW) 113136305

(51) Int. Cl. G01N 23/20008

(52) U.S. Cl. CPC G01N 23/20008; G01N 2223/204; G01N 2223/6116

(57) ABSTRACT

An X-ray measurement system and a composite semiconductor inspection system are provided. The X-ray measurement system includes a multi-axis sample stage, an X-ray generator, an X-ray optical element group, an X-ray detector and a processing device. The X-ray generator includes an electron beam generator, an electromagnetic lens group, an X-ray target material and a vacuum cavity. The X-ray target material receives a focused incident electron beam and generates a measurement X-ray beam. The X-ray target material includes a heat dissipation base material and a plurality of excitation target materials dispersedly embedded in the heat dissipation base material. The X-ray optical element group guides the measurement X-ray beam to the sample to-be-tested. The X-ray detector receives the X-ray signal to-be-measured and generates X-ray spectrum information. The processing device executes a fitting analysis process based on the X-ray spectrum information to obtain structural parameters of the sample to-be-tested.

### CROSS-REFERENCE TO RELATED PATENT APPLICATION

This application claims the benefit of priority to Taiwan Patent Application No. 113136305, filed on Sep. 25, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a measurement system and an inspection system, particularly to an X-ray measurement system and a composite semiconductor inspection system.

### BACKGROUND OF THE DISCLOSURE

The generation of X-rays originated from traditional X-ray tubes, which fundamentally consist of a cathode and an anode target. The cathode generates a high-voltage electron beam that bombards the anode. Depending on the elemental composition of the anode, the internal atoms are excited by energy and undergo transitions, emitting energy in the form of X-rays as they transition from higher energy levels to lower energy levels.

One of the most notable drawbacks of traditional X-ray tubes lies in the design of the solid anodes. Typically, solid anodes are formed through thin-film deposition. Prolonged bombardment by high-voltage electron beams often causes localized or widespread damage to the anode target, significantly impacting the X-ray flux generated.

To address this challenge, modern technologies have developed rotating anode targets and liquid-metal jet targets. However, these solutions also have corresponding drawbacks. Rotating anode targets utilize the variation of the electron beam's bombardment position on the target to extend its lifespan and enhance X-ray flux. However, when changing the target position, the X-ray optical path requires realignment, and the mechanical design becomes more complex. As for liquid-metal jet targets, they leverage the flow characteristics of liquid metal to enhance X-ray flux. However, they have the disadvantage of high material and cost consumption, as the liquid metal requires periodic replacement or replenishment.

### SUMMARY OF THE DISCLOSURE

The technical problem addressed by the present disclosure lies in overcoming the deficiencies of the prior art by providing an X-ray measurement system and a composite semiconductor inspection system capable of effectively resolving the issue of reduced X-ray flux caused by damage to the anode from electron beam bombardment.

To address the aforementioned technical issues, one of the technical solutions provided by the present disclosure is an X-ray measurement system, comprising a multi-axis sample stage, an X-ray generator, an X-ray optical element group, an X-ray detector, and a processing device. The multi-axis sample stage is configured to carry a sample to-be-tested. The X-ray generator includes an electron beam generator, an electromagnetic lens group, an X-ray target material, and a vacuum chamber. The electron beam generator is configured to generate an incident electron beam. The electromagnetic lens group is configured to focus on the incident electron beam. The X-ray target material, mounted on a target actuating device, receives the focused incident electron beam at an incident angle and generates a measurement X-ray beam. The X-ray target material comprises a heat dissipation base material and a plurality of excitation target materials, which are dispersedly embedded in the heat dissipation base material. The vacuum chamber accommodates the electron beam generator, the electromagnetic lens group, the target actuation device, and the X-ray target, and is provided with a window for the passage of the measurement X-ray beam. The X-ray optical element group is configured to direct the measurement X-ray beam to the sample to-be-tested. The X-ray detector is configured to receive an X-ray signal to-be-measured generated when the measurement X-ray beam irradiates the sample to-be-tested and produces X-ray spectrum information corresponding to the X-ray signal to-be-measured. The processing device is configured to output a measurement result of the sample based on the X-ray spectrum information.

To address the aforementioned technical issues, another technical solution provided by the present disclosure is a composite semiconductor inspection system, comprising a multi-axis sample stage, at least two X-ray measurement subsystems, and a processing device. The multi-axis sample stage is configured to carry a sample to-be-tested. The at least two X-ray measurement subsystems each include an X-ray generator, an X-ray optical element group, and an X-ray detector. The X-ray generator includes an electron beam generator, an electromagnetic lens group, an X-ray target material, and a vacuum chamber. The electron beam generator is configured to generate an incident electron beam. The electromagnetic lens group is configured to focus the incident electron beam while simultaneously controlling its focal position. The X-ray target material, mounted on a target actuating device, receives the focused incident electron beam at an incident angle and generates a measurement X-ray beam. The X-ray target material comprises a heat dissipation base material and a plurality of excitation target materials, which are dispersedly embedded in the heat dissipation base material. The vacuum chamber accommodates the electron beam generator, the electromagnetic lens group, the target actuating device, and the X-ray target, and is provided with a window for the passage of the measurement X-ray beam. The X-ray optical element group is configured to direct the measurement X-ray beam to the sample to-be-tested. The X-ray detector is configured to receive an X-ray signal to-be-measured generated when the measurement X-ray beam irradiates the sample to-be-tested and to produce X-ray spectrum information corresponding to the X-ray signal to-be-measured. The processing device is configured to output a measurement result of the sample to-be-tested based on the X-ray spectrum information generated by the at least two X-ray measurement subsystems.

To address the aforementioned technical issues, yet another technical solution provided by the present disclosure is a composite semiconductor inspection system, comprising a multi-axis sample stage, an optical measurement subsystem, an X-ray measurement subsystem, and a processing device. The multi-axis sample stage is configured to carry a sample to-be-tested. The optical measurement subsystem includes a light source generator, an incident-end optical element group, a receiving-end optical element group, and an optical receiver. The light source generator is configured to produce a measurement light beam with a wavelength within an optical wavelength range, which covers at least an ultraviolet band to a near-infrared band. The incident-end optical element group is configured to direct the measurement light beam to the sample to-be-tested. The receiving-end optical element group is configured to receive an optical signal to-be-measured generated when the measurement light beam irradiates the sample to-be-tested. The optical receiver is configured to receive the optical signal to-be-measured guided by the receiving-end optical element group and to produce optical spectrum information corresponding to the optical signal to-be-measured. The X-ray measurement subsystem includes an X-ray generator, an X-ray optical component group, and an X-ray detector. The X-ray generator includes an electron beam generator, an electromagnetic lens group, an X-ray target, and a vacuum chamber. The electron beam generator is configured to produce an incident electron beam. The electromagnetic lens group is configured to focus an incident electron beam while simultaneously controlling its focal position. The X-ray target, mounted on a target actuation device, receives the focused incident electron beam at an incident angle and generates a measurement X-ray beam. The X-ray target comprises a heat dissipation base material and a plurality of excitation target materials, which are dispersedly embedded in the heat dissipation base material. The vacuum chamber accommodates the electron beam generator, the electromagnetic lens group, the target actuating device, and the X-ray target, and is provided with a window for the passage of the measurement X-ray beam. The X-ray optical component group is configured to direct the measurement X-ray beam to the sample to-be-tested. The X-ray detector is configured to receive an X-ray signal to-be-measured generated when the measurement X-ray beam irradiates the sample to-be-tested and to produce X-ray spectrum information corresponding to the X-ray signal to-be-measured. The processing device is configured to output a measurement result of the sample to-be-tested based on the optical spectrum information and the X-ray spectrum information.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The embodiments described may be better understood by reference to the following description and the accompanying drawings, in which:

FIG. 1 is a functional block diagram of the X-ray measurement system according to the first embodiment of the present disclosure.

FIG. 2 is a schematic diagram of the system architecture of the X-ray measurement system according to the first embodiment of the present disclosure.

FIG. 3 is a schematic diagram of the structure of the X-ray generator according to the first embodiment of the present disclosure.

FIG. 4 is a first top view of the X-ray target material according to the first embodiment of the present disclosure.

FIG. 5 is a first cross-sectional view of the X-ray target material along section line I-I according to the first embodiment of the present disclosure.

FIG. 6 is a second top view of the X-ray target material according to the first embodiment of the present disclosure.

FIG. 7 is a second cross-sectional view of the X-ray target material along section line II-II according to the first embodiment of the present disclosure.

FIG. 8 is a third top view of the X-ray target material according to the first embodiment of the present disclosure.

FIG. 9 is a third cross-sectional view of the X-ray target material along section line III-III according to the first embodiment of the present disclosure.

FIG. 10 is a fourth top view of the X-ray target material according to the first embodiment of the present disclosure.

FIG. 11 is a fourth cross-sectional view of the X-ray target material along section line IV-IV according to the first embodiment of the present disclosure.

FIG. 12 is a functional block diagram of the composite semiconductor inspection system according to the second embodiment of the present disclosure.

FIG. 13 is a schematic diagram of the first operational mode of the composite semiconductor inspection system according to the second embodiment of the present disclosure.

FIG. 14 is a schematic diagram of the second operational mode of the composite semiconductor inspection system according to the second embodiment of the present disclosure.

FIG. 15 is a schematic diagram of the third operational mode of the composite semiconductor inspection system according to the second embodiment of the present disclosure.

FIG. 16 is a functional block diagram of the composite semiconductor inspection system according to the third embodiment of the present disclosure.

FIG. 17 is a top view of the measurement architecture of the composite semiconductor inspection system according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be configured to describe various components, signals or the like, which are for distinguishing one component/signal from another one only, and are not intended to, nor should be construed to impose any substantive limitations on the components, signals or the like.

### First Embodiment

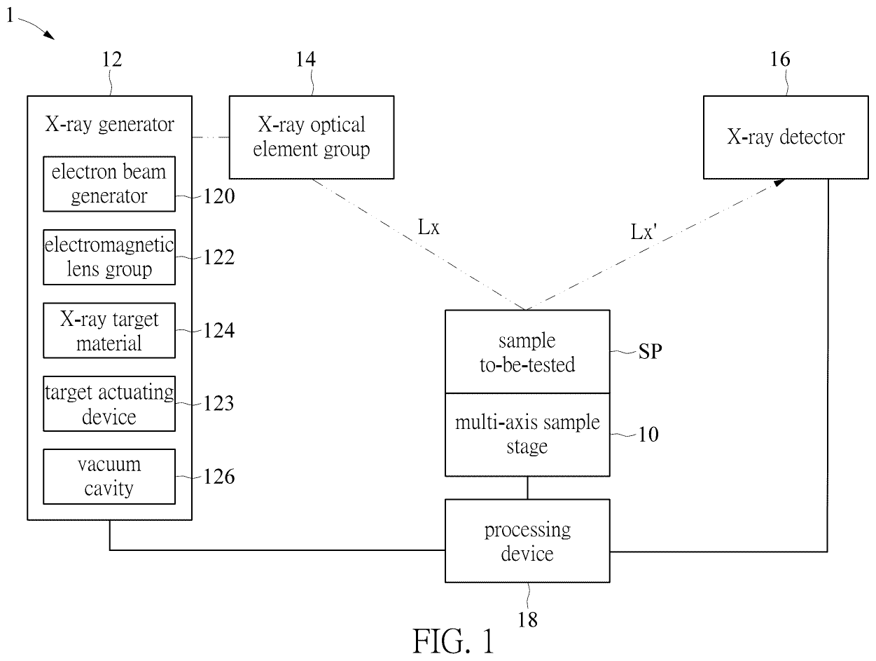

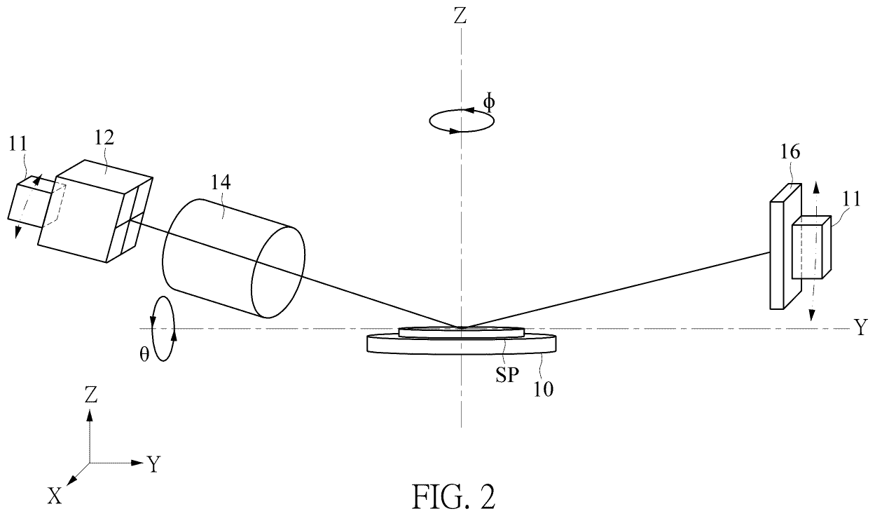

FIG. 1 is a functional block diagram of the X-ray measurement system according to the first embodiment of the present disclosure. FIG. 2 is a schematic diagram of the system architecture of the X-ray measurement system according to the first embodiment of the present disclosure.

Referring to FIGS. 1 and 2, the first embodiment of the present disclosure provides an X-ray measurement system 1, comprising a multi-axis sample stage 10, an X-ray generator 12, an X-ray optical element group 14, an X-ray detector 16, and a processing device 18.

The multi-axis sample stage 10 is a movable platform with the plurality of axis, which may, for example, be a three-axis tilting platform or a gimbal tilting platform configured to carry a sample to-be-tested SP. The multi-axis sample stage 10 may include a stage movement mechanism and a stage rotation mechanism. The stage movement mechanism may include, for example, stepper motors corresponding to three axes, so as to allow the sample to-be-tested SP to move along one or more of the X-axis, Y-axis, and Z-axis. By controlling the stepper motor for each axis, the sample to-be-tested SP can be precisely moved to different positions. For instance, in the case of a gimbal tilting platform, the stage rotation mechanism may include a gimbal joint connected to part of the platform, enabling the sample to-be-tested SP to rotate around one or more of the X-axis, Y-axis, and Z-axis. Specifically, the rotation mechanism of the multi-axis sample stage 10 may include controls for azimuthal angle θ rotation around the Y-axis and azimuthal angle φ rotation around the Z-axis, thus achieving comprehensive scanning of the sample to-be-tested SP.

In this embodiment of the present disclosure, the sample to-be-tested SP may be a wafer, a photomask, a photomask film, or a semiconductor component with multilayer films. Examples include metal-oxide-semiconductor field-effect transistors (MOSFETs), planar MOSFETs, complementary field-effect transistors (CFETs), FinFETs, gate-all-around field-effect transistors (GAAFETs), high electron mobility transistors (HEMTs), heterojunction field-effect transistors (HFETs), dual-gate MOSFETs (DG-MOSFETs), or fast-recovery epitaxial diode field-effect transistors (FREDFETs).

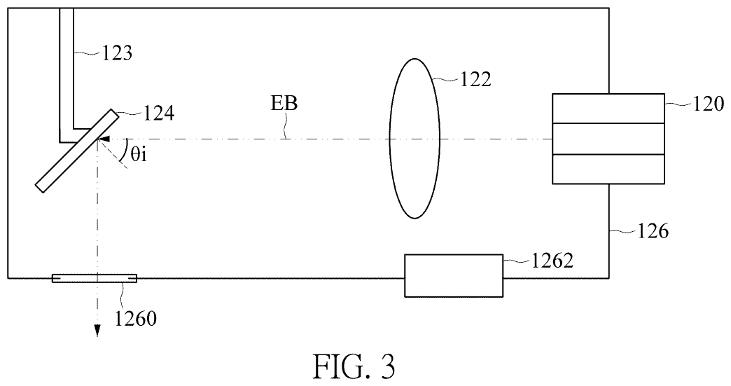

FIG. 3 is a schematic diagram of the structure of the X-ray generator according to the first embodiment of the present disclosure. As shown in FIG. 3, the X-ray generator 12 comprises an electron beam generator 120, an electromagnetic lens group 122, an X-ray target material 124, and a vacuum cavity 126.

The vacuum cavity 126 has an accommodating space for housing the electron beam generator 120, the electromagnetic lens group 122, the target actuating device 123, and the X-ray target material 124. The vacuum cavity 126 is equipped with a window 1260 for the passage of the measurement X-ray beam. The vacuum cavity 126 is a chamber capable of withstanding a high vacuum and providing an enclosed space isolated from the external environment and is further equipped with one or more vacuum pumps 1262 to maintain a vacuum level above 10⁻⁷ torr, thereby providing an environment suitable for electron beams. An X-ray emission window 3 allows X-rays to exit the cavity without being absorbed by the vacuum cavity. The electron beam generator 120 may include one or more cathode electron guns to generate an incident electron beam EB, which is directed at the X-ray target material 124 to emit X-rays. The electromagnetic lens group 122 may include one or more electromagnetic lenses for focusing the incident electron beam EB onto the X-ray target material 124 and controlling the shape and focal position of the incident electron beam EB upon hitting the X-ray target material 124.

On the other hand, the X-ray target material 124 may be mounted on the target actuating device 123. The X-ray target material 124 receives the focused incident electron beam EB at a specific incident angle θi and generates a measurement X-ray beam Lx. The target actuating device 123, similar to the multi-axis sample stage 10, enables the X-ray target material 124 to rotate about one or more specific reference axis, such as the X-axis, Y-axis, and Z-axis. The X-ray target material 124 may be made of copper, molybdenum, cobalt, or high-entropy alloy materials (HEAMs). High-entropy alloy materials may include one or more of CuZnMnAl, AlCrTiTaZr, AlCoCrFeNiTi, AlCoCrFeNi, and AlFeCrNiMo. By selecting different target materials, it is possible to generate measurement X-ray beam (Lx) with varying energy levels or wavelengths (or frequencies).

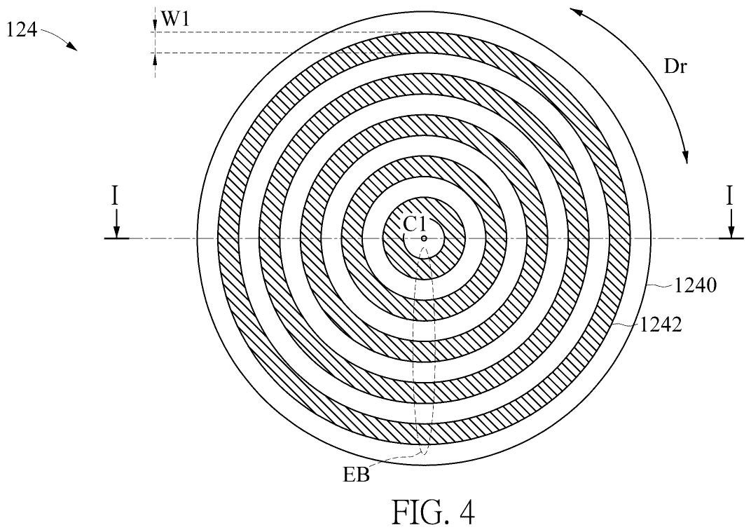

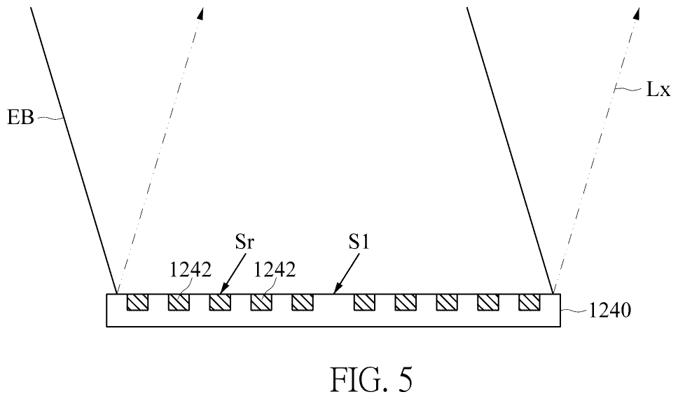

FIG. 4 is a first top view of the X-ray target material according to the first embodiment of the present disclosure, and FIG. 5 is a first cross-sectional view along section line I-I of the X-ray target material. Referring to FIGS. 4 and 5, in this embodiment, the X-ray target material 124, acting as the anode, includes a heat dissipation base material 1240 and a plurality of excitation target materials 1242, with the plurality of excitation target materials 1242 dispersedly embedded in the heat dissipation base material 1240. The heat dissipation base material 1240 may, for example, be a plate. In the top view, it may appear as a circular plate. The plurality of excitation target materials 1242 are arranged as a plurality of ring bodies sequentially from an inside to an outside around a center C1 of the plate.

More specifically, the heat dissipation base material 1240 may, for example, be a plate with the plurality of grooves. The plurality of excitation target materials 1242 may be arranged in a concentric circular pattern within the grooves, that is, be embedded in the heat dissipation base material 1240. It can be seen from the cross-sectional view (FIG. 5) that each ring body formed by each of the plurality of excitation target materials 1242 has a rectangular cross-section and features a light-receiving surface Sr that does not contact the plate (heat dissipation base material 1240). Compared to conventional X-ray target structures, this configuration increases the contact area between the plurality of excitation target materials 1242 and the heat dissipation base material 1240, thereby enabling the X-ray target material 124 to withstand higher flux incident electron beams EB. This, in turn, enhances the intensity of the generated measurement X-ray beam Lx. In some embodiments, the heat dissipation base material 1240 may include materials with high thermal conductivity, such as diamond, graphite, graphene, silicon carbide, or boron nitride.

On the other hand, the X-ray target material 124 can be excited by the incident electron beam EB using various methods. For example, as shown in FIG. 5, by adjusting the incident angle θi, the X-ray target material 124 is tilted relative to the incident electron beam EB, so as to achieve the line focus principle. This reduces repeated absorption of X-rays, facilitates heat dissipation, and enables control over the size of the X-ray beam to meet ideal dimensions.

Another method can be observed in FIG. 4. When the X-ray target material 124 receives the focused incident electron beam EB and generates the measurement X-ray beam Lx, the target actuating device 123 can rotate the X-ray target material 124, causing the incident position of the electron beam EB on the X-ray target material 124 to change over time. For instance, the target actuating device 123 can rotate the X-ray target material 124 in a clockwise or counterclockwise direction Dr around the center C1. Simultaneously, the incident electron beam EB strikes the same point to produce a stable measurement X-ray beam Lx while allowing unexposed excitation target material 1242 and the heat dissipation base material 1240 to dissipate heat.

Moreover, each ring body formed by each of the plurality of excitation target materials 1242 has a width W1 along the radial direction of the circular plate, which can be uniform or variable. When each width W1 is identical, it offers the advantage of simplified manufacturing. On the other hand, to balance the lifespan of the plurality of excitation target materials, the width W1 of each ring body can be designed according to the beam shape of the incident electron beam EB. This ensures that both the inner and outer rings experience equal irradiation areas, thereby preventing the need to replace the entire X-ray target material 124 due to premature wear of either the inner or outer rings.

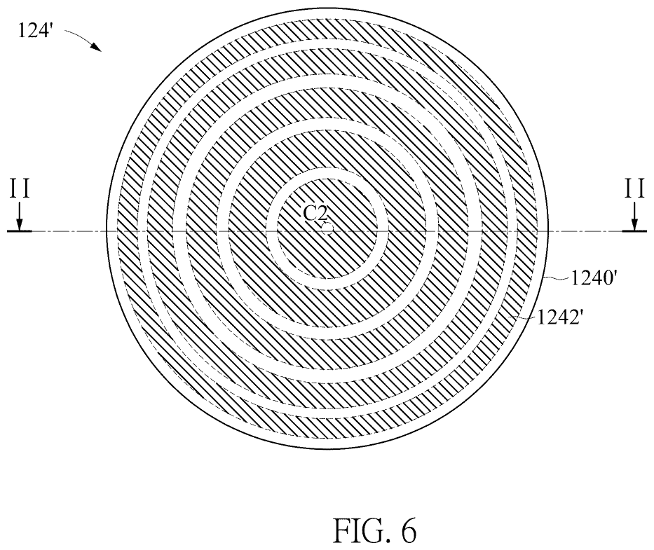

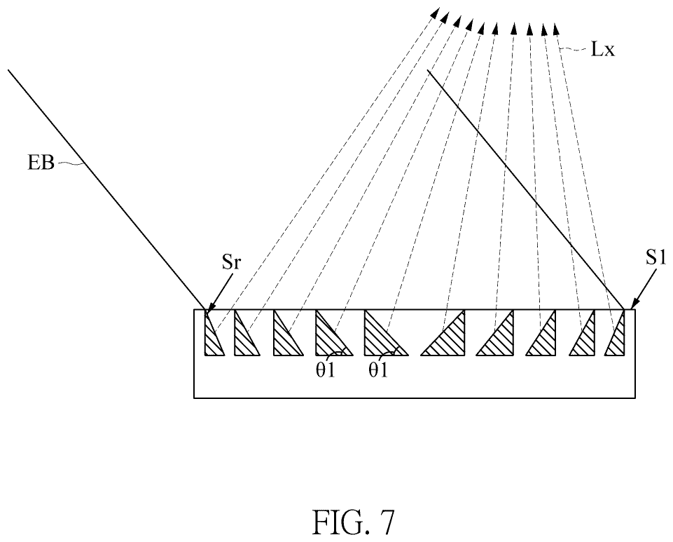

FIG. 6 is a second top view of the X-ray target material in the first embodiment, and FIG. 7 is a second cross-sectional view along section line II-II of the X-ray target material. Referring to FIGS. 6 and 7, the first embodiment of the present disclosure provides another X-ray target material 124′. Similar to FIGS. 4 and 5, a plurality of excitation target materials 1242′ are embedded in the heat dissipation base material 1240′. The heat dissipation base material 1240′ may, for example, be a circular plate. The plurality of excitation target materials 1242′ are arranged as a plurality of ring bodies arranged sequentially from the inside to the outside around the center C2 of the plate. Unlike FIGS. 4 and 5, each ring body has a triangular cross-section, which may, for example, be a right triangle with a hypotenuse corresponding to the light-receiving surface Sr. The hypotenuse is inclined at a predetermined angle θ1 relative to the first surface S1 of the plate. The predetermined angles θ1 of the plurality of ring bodies differ from one another. For example, the predetermined angles θ1 may increase radially outward from the center C2 of the plate. In some embodiments, the gradient range of the predetermined angles θ1 may range from 30 to 45 degrees, though the present disclosure is not limited to this range.

Specifically, the predetermined angle θ1 is an inclination angle derived from the geometry of the plurality of excitation target materials 1242′. This design reduces the attenuation of the measurement X-ray beam Lx intensity produced by the plurality of excitation target materials 1242′ under a specific incident angle θi, thus ensuring higher intensity at certain angles. Since the light-receiving surface Sr of each excitation target material 1242′ has a unique angle relative to the first surface S1, the measurement X-ray beam Lx with maximum intensity produced by each excitation target material1242′ corresponds to different angles. With appropriate design, the stronger measurement X-ray beam Lx generated by the plurality of excitation target materials 1242′ can converge at the same point. Furthermore, in addition to the gradual outward increase of the predetermined angle θ1, the angle range must be greater than 0 degrees.

As a result, the dispersed embedding of the plurality of excitation target materials 1242′ within the heat dissipation base material 1240′ increases the contact area between the plurality of excitation target materials 1242′ and the heat dissipation base material 1240′, thereby enhancing heat dissipation efficiency. The specific angle design allows the stronger measurement X-ray beam Lx to converge at the same point, so as to achieve a collimating effect. Similar to FIG. 4, the X-ray target material 124′ in FIGS. 6 and 7 can also be rotated by the target actuating device 123, thus causing the incident position of the electron beam EB on the X-ray target material 124′ to vary over time and further improving heat dissipation.

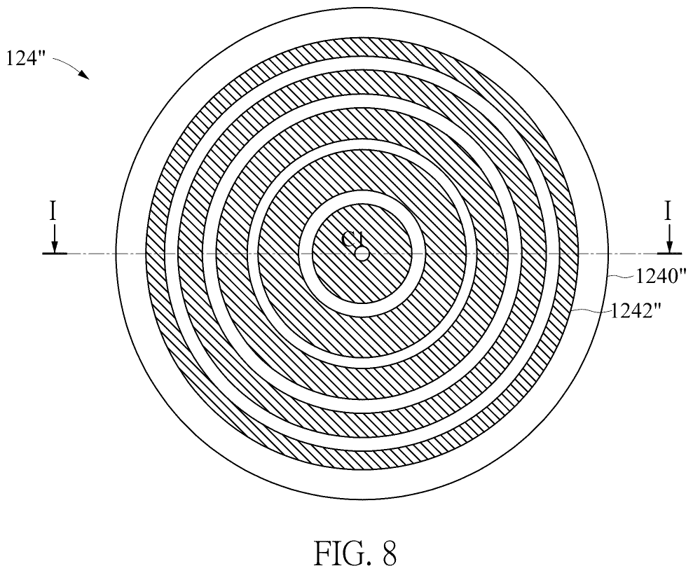

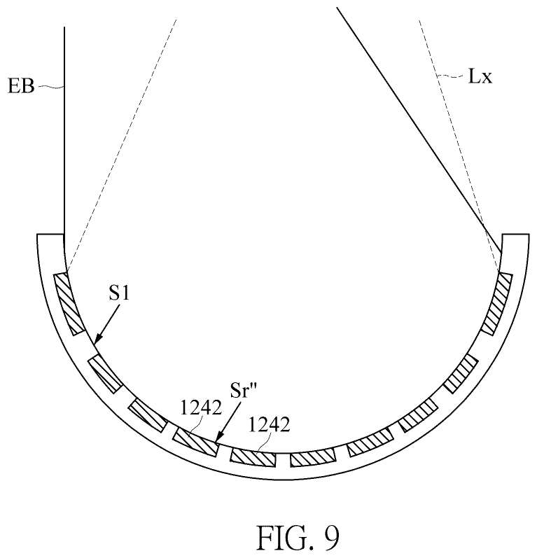

FIG. 8 illustrates a third top view of the X-ray target in the first embodiment, and FIG. 9 shows a third cross-sectional view along section line III-III of the X-ray target. Referring to FIGS. 8 and 9, the first embodiment provides another X-ray target material 124″. Similar to FIGS. 4 and 5, the plurality of excitation target materials 1242″ are embedded in the heat dissipation base material 1240″, arranged as a plurality of ring bodies arranged sequentially from the inside to the outside around the center of the plate. From the top view, the heat dissipation base material 1240″ may be a circular plate. However, as seen in the side view, unlike FIGS. 4 and 5, the circular plate is actually a bowl-shaped plate. Each ring body formed by each of the plurality of excitation target materials 1242″ surrounds the central bottom C3 of the bowl-shaped plate and features a light-receiving surface Sr″ that does not contact the bowl-shaped plate.

Because the heat dissipation base material 1240″ is bowl-shaped, the light-receiving surfaces Sr″ of the plurality of excitation target materials 1242″ can vary in angle relative to the incident electron beam EB, depending on the morphology of the heat dissipation base material 1240″. This configuration is similar to the angle-gradient design described in FIGS. 6 and 7. Accordingly, the positions of the plurality of excitation target materials 1242″ can be designed to control the angles of the light-receiving surfaces Sr″ relative to the incident electron beam EB, thereby ensuring that the measurement X-ray beam Lx exhibits higher intensity in specific directions.

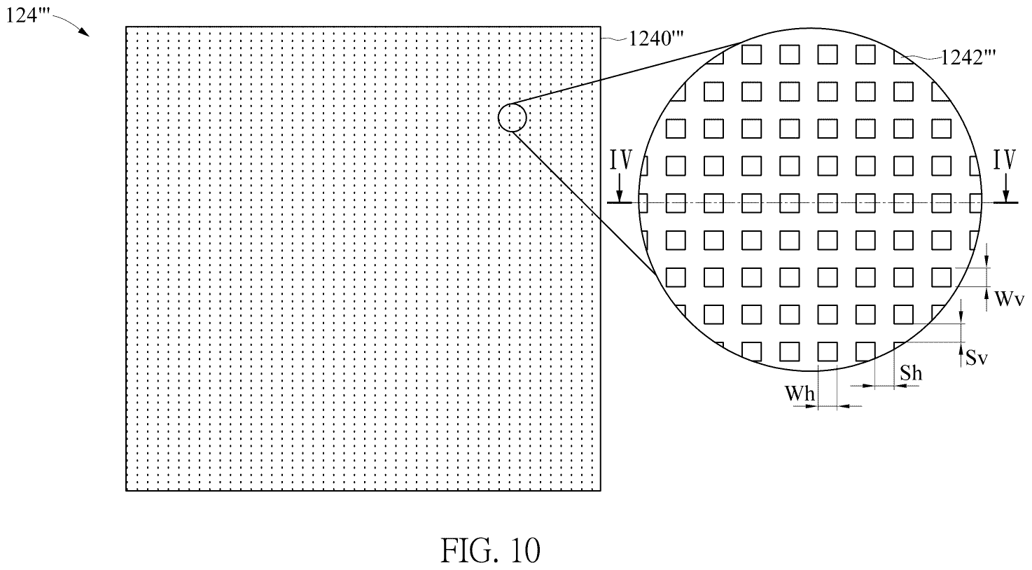

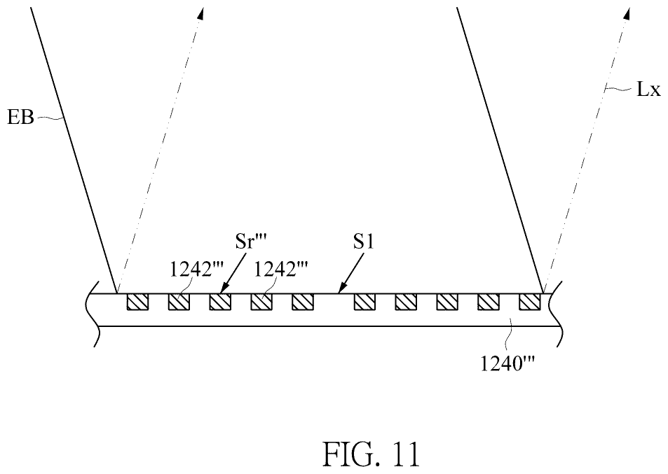

FIG. 10 provides a fourth top view of the X-ray target in the first embodiment, and FIG. 11 illustrates a fourth cross-sectional view along section line IV-IV. The heat dissipation base material 1240′″ is a plate (e.g., a rectangular plate), and the plurality of excitation target materials 1242′″ are a plurality of blocks arranged in an array on the first surface S1 of the plate. Each block features a light-receiving surface Sr′″ that does not contact the plate.

In this example, the area of the electron beam cross-section formed by the incident electron beam on the X-ray target material 124′″ is smaller than the area of the first surface S1 of the plate. For instance, the size of the incident electron beam EB hitting the X-ray target material 124′″ can be less than 50 microns×50 microns, thereby resulting in a smaller X-ray spot size. By finely dividing and embedding the plurality of excitation target materials 1242′″ into the heat dissipation base material 1240′″, the contact area between the plurality of excitation target materials 1242′″ and the heat dissipation base material 1240′″ is significantly increased.

As shown in FIGS. 10 and 11, each block formed by each of the plurality of excitation target materials 1242′″ is a hexahedron (e.g., a cube) spaced apart by a vertical distance Sᵥ and a horizontal distance Sₕ in the top view. Each block has a vertical width Wv and a horizontal width Wh. In a specific embodiment, each block appears as a square in the top view, with equal length and width, i.e., Wᵥ=Wₕ. The vertical distance Sᵥ and horizontal distance Sₕ may, for example, be half the length of the block, i.e., Sᵥ=½ Wᵥ, Sₕ=½ Wₕ. Under this condition, the total contact area between the plurality of excitation target materials 1242′″ and the heat dissipation base material 1240′″ can increase by more than double compared to undivided excitation target material, thereby enhancing heat dissipation efficiency. This enables the X-ray target material 124′″ to withstand higher fluxes of the incident electron beam EB.

It is emphasized that the diameter of the incident electron beam EB should ideally be larger than the side length (i.e., width W, and Wₕ) of each block formed by each of the plurality of excitation target materials 1242′″. For example, the diameter may be 10, 20, 30, or 50 times the width Wᵥ and Wₕ. On the other hand, the widths Wᵥ and Wₕ can be greater than or equal to the vertical distance Sᵥ and horizontal distance Sₕ, respectively. For instance, the ratio of Sᵥ/Sₕ to Wᵥ/Wₕ may be 1:1, 1:0.5, 1:0.2, or 1:0.1.

Referring again to FIGS. 1 and 2, the X-ray optical element group 14 is configured to guide the measurement X-ray beam Lx to the sample to-be-tested. The X-ray optical element group 14 may include one or more X-ray optical elements, such as an X-ray mirror assembly, X-ray slits, and X-ray collimators, sequentially arranged between the X-ray generator 12 and the sample to-be-tested SP. The X-ray mirror assembly may have a multilayer structure to horizontally and vertically focus the measurement X-ray beam Lx. The X-ray slits may control the flux of the measurement X-ray beam Lx incident on the sample to-be-tested SP and also control its vertical divergence angle. The measurement X-ray beam Lx is primarily used for X-ray analysis techniques and may, for example, have a wavelength greater than 0.1 nm, including hard X-rays, soft X-rays, or gamma rays.

When the measurement X-ray beam Lx irradiates the sample to-be-tested SP, the X-ray signal to-be-measured Lx′ is generated due to reflection, diffraction, scattering, or penetration, depending on the incident angle. By positioning the X-ray detector 16 appropriately, it can receive the X-ray signal to-be-measured Lx′ generated by these effects and produce X-ray spectrum information corresponding to the X-ray signal to-be-measured Lx′. The X-ray detector 16 can be a high spatial resolution detector with one or more dimensions and can detect the X-ray signal to-be-measured Lx′ with energy greater than 1 keV.

During the measurement process, the processing device 18 can control the movement and/or rotation of the multi-axis sample stage 10, thereby enabling the X-ray detector 16 to receive the plurality of X-ray signals to-be-measured Lx′ generated at various X-ray measurement angles. The device generates the plurality of pieces of X-ray spectrum data corresponding to the plurality of X-ray signals to-be-measured Lx′.

Additionally, the X-ray generator 12 and the X-ray detector 16 are mounted on the X-ray rotation mechanism 11. The X-ray rotation mechanism 11 may include one or more mechanical arms connected to the X-ray generator 12 and the X-ray detector 16, each arm having a plurality of degrees of freedom. This configuration allows the X-ray generator 12 and the X-ray detector 16 to simultaneously or independently rotate around the sample to-be-tested SP. Under this setup, while the processing device 18 controls the movement and/or rotation of the multi-axis sample stage 10, it can also control the rotation of the X-ray rotation mechanism 11. This ensures that the X-ray generator 12 can emit the measurement X-ray beam Lx from a plurality of directions, while the X-ray detector 16 receives the plurality of X-ray signal to-be-measured Lx′ generated at various X-ray measurement angles and produces the plurality of pieces of X-ray spectrum data corresponding to the plurality of X-ray signals to-be-measured Lx′.

The processing device 18 may be a computer system comprising a processor and memory, configured to execute stored instruction sets or code to control the multi-axis sample stage 10 and other controllable components within the X-ray measurement system 1. Furthermore, the processing device 18 is configured to output the X-ray spectrum information as the measurement result of the sample to-be-tested SP or to perform further fitting analysis on the X-ray spectrum information to obtain the structural parameters of the sample to-be-tested SP as the measurement result. The structural parameters may include one or more of the thickness, roughness, density, critical dimension (CD), line edge roughness (LER), refractive index, and extinction coefficient.

For example, the processing device 18 can fit the X-ray spectrum information. The X-ray spectrum information may include reflectance spectra obtained by irradiating the sample to-be-tested SP with the measurement X-ray beam Lx at the plurality of different incident angles. The fitting results may provide structural parameters of the sample to-be-tested SP, such as those of semiconductor components like MOSFETs, planar MOSFETs, CFETs, FinFETs, HEMTs, HFETs, DG-MOSFETs, and FREDFETs.

Specifically, the processing device 18 can perform fitting analysis on the X-ray spectrum information to inversely reconstruct key structural parameters of the sample to-be-tested SP. The X-ray spectrum information may result from interactions between the measurement X-ray beam Lx and the sample to-be-tested SP, such as reflection, scattering, diffraction, or fluorescence excitation. For example, the X-ray spectrum information may include X-ray reflectance spectra, X-ray scattering spectra, X-ray diffraction spectra, and X-ray fluorescence spectra. By appropriately controlling the azimuth angles θ and φ, the X-ray detector 16 can collect the X-ray signal to-be-measured Lx′ generated by reflection to obtain X-ray reflectance spectra. Similarly, X-ray scattering, diffraction, and fluorescence spectra can be obtained by collecting the X-ray signal to-be-measured Lx′ resulting from scattering, diffraction, and fluorescence excitation. During the fitting analysis, the processing device 18 can perform various X-ray analyses, including X-ray reflectivity (XRR) analysis, X-ray diffraction (XRD) analysis, small-angle X-ray scattering (SAXS) analysis, and X-ray fluorescence (XRF) analysis, to inversely reconstruct key structural parameters of the sample to-be-tested SP.

For example, in XRR analysis, when the measurement X-ray beam Lx irradiates the sample to-be-tested SP and the X-ray detector collects spectral signals over a range of angles, an XRR spectrum is obtained. XRR analysis can determine the structural parameters of the sample to-be-tested SP. For instance, when the sample to-be-tested SP includes the plurality of layers, XRR analysis can determine the density, thickness, and roughness of each layer based on the collected X-ray reflectance spectrum information. On the other hand, when the sample to-be-tested SP contains microelements, XRR analysis can determine the orientation and dimensions of these microelements based on the X-ray reflectance spectrum. However, the present disclosure is not limited to this. The aforementioned X-ray analyses can also be configured to analyze structural parameters of various types of samples SP, including MOSFETs, planar MOSFETs, CFETs, FinFETs, GAAFETs, HEMTs, HFETs, DG-MOSFETs, and FREDFETs.

### Second Embodiment

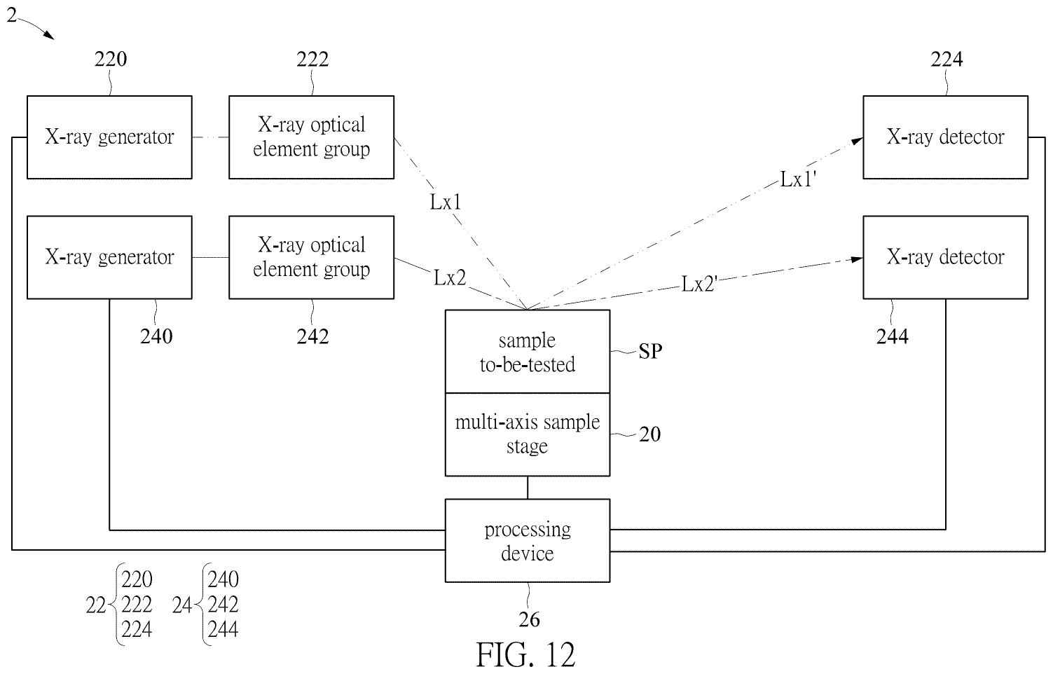

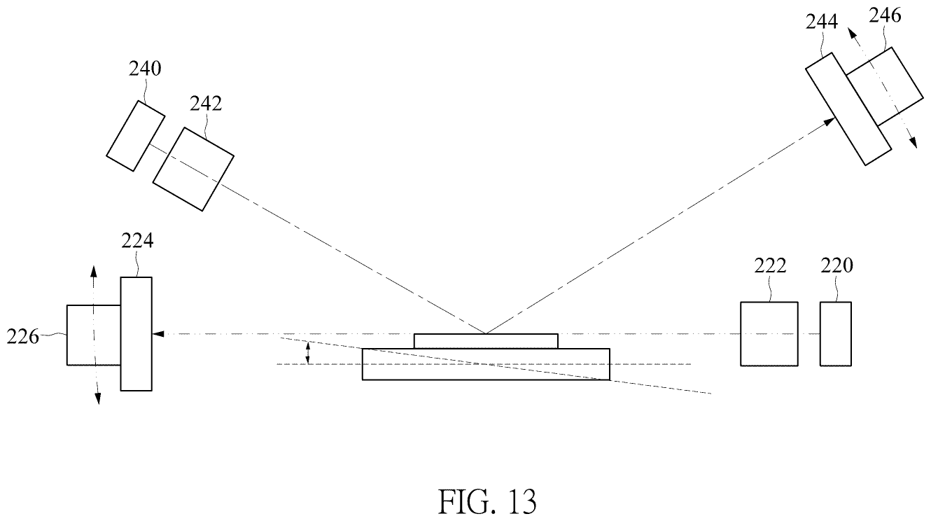

FIG. 12 depicts the functional block diagram of the composite semiconductor inspection system of the second embodiment of the present disclosure. FIG. 13 illustrates the first operating mode of the composite semiconductor inspection system of the second embodiment. As shown in FIG. 12, the second embodiment of the present disclosure provides a composite semiconductor inspection system 2, comprising a multi-axis sample stage 20, X-ray measurement subsystems 22 and 24, and a processing device 26. In this embodiment, components identical or similar to those in the first embodiment are marked with corresponding reference numerals, and their descriptions are omitted for brevity.

The multi-axis sample stage 20 is similar to the multi-axis sample stage 10 in the first embodiment. The X-ray measurement subsystems 22 and 24 are fundamentally similar to the X-ray measurement system 1. The X-ray measurement subsystem 22 comprises an X-ray generator 220, an X-ray optical element group 222, and an X-ray detector 224. The X-ray measurement subsystem 24 comprises an X-ray generator 240, an X-ray optical element group 242, and an X-ray detector 244. The X-ray generators 220 and 240 respectively produce measurement X-ray beams Lx1 and Lx2, which may, for example, have a wavelength range greater than 0.1 nanometers and include hard X-ray beams, soft X-ray beams, or gamma-ray beams.

It should be noted that the X-ray generators 220 and 240 adopt the same configuration as the X-ray generator 12 in the first embodiment, and utilize an X-ray target as the anode, which includes the plurality of excitation target materials dispersedly embedded into a heat dissipation base material to enhance heat dissipation efficiency. Details of the X-ray generators 220 and 240 can be found in the first embodiment and are not repeated here.

When the measurement X-ray beams Lx1 and Lx2 irradiate the sample to-be-tested SP, depending on the incident angles, they respectively generate X-ray signals to-be-measured Lx1′ and Lx2′ through reflection, diffraction, scattering, or penetration. By positioning the X-ray detectors 224 and 244 appropriately, these detectors can respectively receive the X-ray signals to-be-measured Lx1′ and Lx2′ and produce X-ray spectrum data corresponding to the X-ray signals to-be-measured Lx1′ and Lx2′.

In the first operating mode, the X-ray detectors 224 and 244 can be mounted on the X-ray rotation mechanisms 226 and 246, respectively. Each X-ray rotation mechanism may include one or more mechanical arms, with each arm having a plurality of degrees of freedom. This allows the X-ray detectors 224 and 244 to rotate simultaneously or independently around the sample to-be-tested SP.

In this mode, the X-ray measurement subsystems 22 and 24 can be arranged in the same plane, and the X-ray generators 220 and 240 remain stationary. It should be noted that the positions of the X-ray detectors 224 and 244 may vary based on the positions of the X-ray signals to-be-measured Lx1′ and Lx2′ generated after the measurement X-ray beams Lx1 and Lx2 irradiate the sample to-be-tested SP.

In some embodiments, the X-ray measurement paths formed by the subsystems 22 and 24 can be perpendicular to each other to fulfill anisotropic measurement requirements. For example, while the X-ray measurement subsystem 22 performs measurements, the subsystem 24 can simultaneously perform measurements at a specified azimuth angle ¢, thereby enabling simultaneous anisotropic measurements. This setup significantly increases data throughput and reduces the time required to generate X-ray spectrum data. By ensuring consistent measurement conditions for the X-ray measurement subsystems 22 and 24, isotropic measurement requirements can also be fulfilled.

In addition to adjusting the positions of the X-ray detectors 224 and 244, the multi-axis sample stage 20 can also be adjusted based on the angular range to-be-measured. For instance, if the measurement angular range spans θA to θB, the X-ray measurement subsystem 22 can measure the range from θA to (θA+θB)/2, while the subsystem 24 measures from (θA+θB)/2 to θB. To achieve the purpose, the multi-axis sample stage 20 must rotate within a range from θA to (θA+θB)/2. By simultaneously operating the subsystems 22 and 24 alongside the multi-axis sample stage 20, the angular ranges θA to (θA+θB)/2 and (θA+θB)/2 to OB can be measured simultaneously. In this first operating mode, data across the angular range θA to OB can be collected in half the time. Moreover, by maintaining the X-ray generators 220 and 240 stationary, variations in the optical path caused by the operation of the X-ray generators can be minimized, thereby reducing the time required for optical path recalibration.

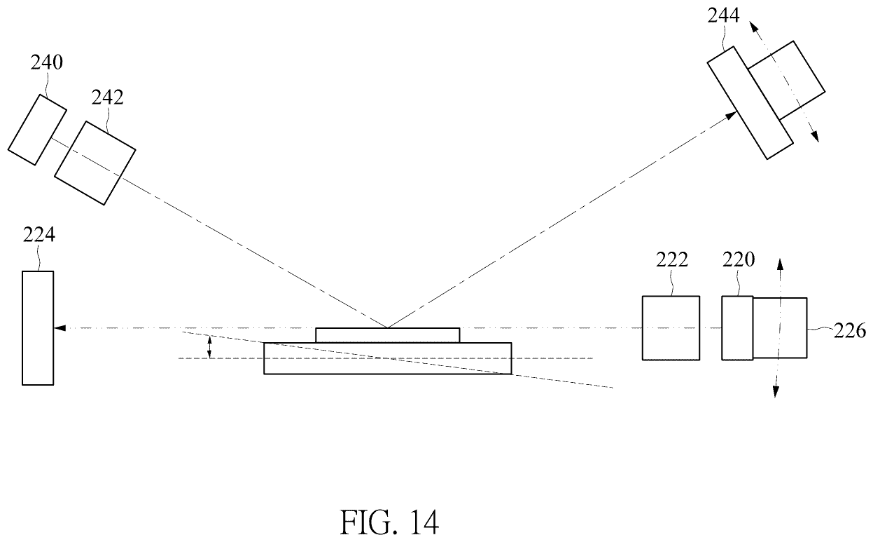

FIG. 14 illustrates the second operating mode of the composite semiconductor inspection system of the second embodiment. As shown in FIG. 14, in the second operating mode, the X-ray generator 220 and the X-ray detector 244 can be mounted on the X-ray rotation mechanisms 226 and 246, respectively. Each X-ray rotation mechanism may include one or more mechanical arms, and has a plurality of degrees of freedom. This configuration allows the X-ray generator 220 and the X-ray detector 224 to rotate simultaneously or independently around the sample to-be-tested SP.

In the second operating mode, the X-ray measurement subsystems 22 and 24 can be arranged in the same plane. However, unlike FIG. 13, the X-ray generator 240 and the X-ray detector 224 positioned on one side of the sample to-be-tested SP are stationary, while the X-ray generator 220 and the X-ray detector 244 positioned on the opposite side of the sample to-be-tested SP are movable. In other embodiments, the X-ray generator 240 and the X-ray detector 224 can be mounted on the X-ray rotation mechanisms 226 and 246, respectively, while the X-ray generator 220 and the X-ray detector 244 on the opposite side of the sample to-be-tested SP remain stationary.

It should be noted that the positions of the X-ray generator 220 and the X-ray detector 244 can be adjusted based on the locations of the X-ray signals to-be-measured Lx1′ and Lx2′ generated after the measurement X-ray beams Lx1 and Lx2 irradiate the sample to-be-tested SP. For instance, if the angular measurement range spans θA to θB, the X-ray measurement subsystem 22 can cover the angular range from θA to (θA+B)/2, while the subsystem 24 covers the range from (θA+θB)/2 to θB. To achieve the purpose, the multi-axis sample stage 20 must rotate within the angular range from θA to (θA+θB)/2. By simultaneously operating the X-ray measurement subsystems 22 and 24, along with the motion of the multi-axis sample stage 20, it is possible to measure the entire angular range from θA to OB within half the time. Additionally, this operating mode simplifies the movements of the mechanism, as only the X-ray generator and the X-ray detector on one side of the sample to-be-tested SP need to be moved.

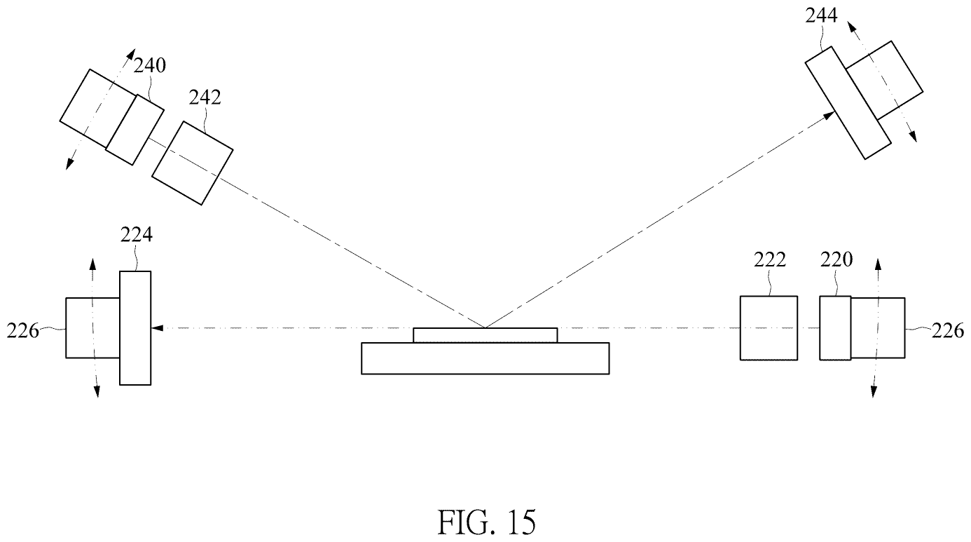

FIG. 15 illustrates the third operating mode of the composite semiconductor inspection system of the second embodiment. As shown in FIG. 15, in the third operating mode, the X-ray generators 220 and 240, along with the X-ray detectors 224 and 244, are mounted on X-ray rotation mechanisms 226, 227, 246, and 247, respectively. Each X-ray rotation mechanism may include one or more mechanical arms with a plurality of degrees of freedom, thereby allowing the X-ray generators 220 and 240, as well as the X-ray detectors 224 and 244, to rotate simultaneously or independently around the sample to-be-tested SP.

In the third operating mode, the X-ray measurement subsystems 22 and 24 are not limited to be in the same plane. However, the multi-axis sample stage 20 can remain fixed, and the X-ray generators 220 and 240 can move to specific positions based on the angular range to-be-measured. The angular measurement ranges of the X-ray measurement subsystems 22 and 24 can differ. For example, if the angular measurement range spans θA to θB, the subsystem 22 can cover the range from θA to (θA+θB)/2, while the subsystem 24 covers the range from (θA+θB)/2 to θB. If the subsystems 22 and 24 are in the same plane, they can simultaneously measure the angular ranges θA to (θA+θB)/2 and (θA+θB)/2 to θB, thereby enabling data collection for the entire angular range from θA to OB in half the time. If the subsystems 22 and 24 are in different spatial planes, simultaneous measurements can be performed in different directions, so as to further reduce the measurement time by half.

Additionally, although two X-ray measurement subsystems 22 and 24 are used in this embodiment, the present disclosure is not limited to this configuration. The number of X-ray measurement subsystems can be designed based on user requirements. Similarly, the number of X-ray generators, X-ray optical element groups, and X-ray detectors is not limited to the quantities shown in FIGS. 12 to 15.

Similar to the first embodiment, the processing device 26 can output the X-ray spectrum data generated by the X-ray measurement subsystems 22 and 24 as the measurement result of the sample to-be-tested SP or further fit the X-ray spectrum data to obtain the structural parameters of the sample to-be-tested SP as the measurement result.

### Third Embodiment

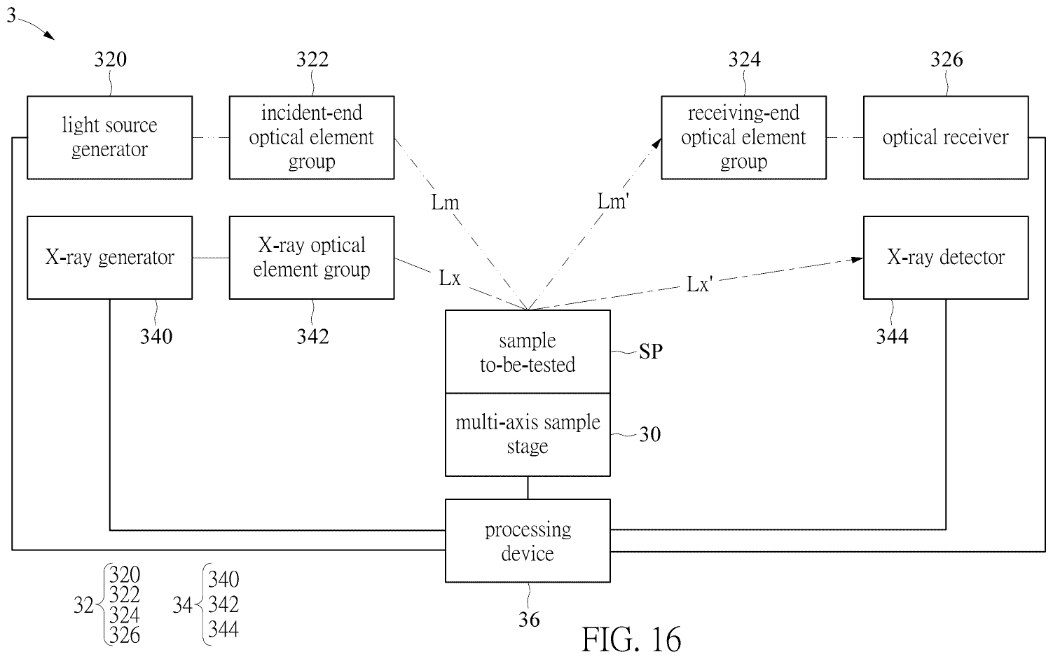

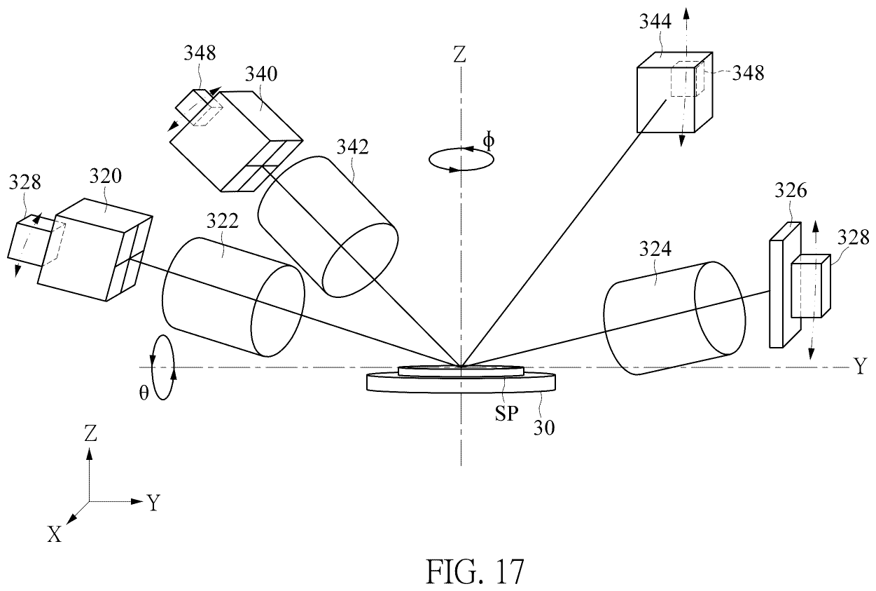

FIG. 16 depicts the functional block diagram of the composite semiconductor inspection system of the third embodiment of the present disclosure. FIG. 17 illustrates the top view of the measurement structure of the composite semiconductor inspection system in the third embodiment.

As shown in FIGS. 16 and 17, the third embodiment of the present disclosure provides a composite semiconductor inspection system 3, comprising a multi-axis sample stage 30, an optical measurement subsystem 32, an X-ray measurement subsystem 34, and a processing device 36.

The multi-axis sample stage 30 is similar to the multi-axis sample stage 10 in the first embodiment and will not be elaborated upon here. The optical measurement subsystem 32 comprises a light source generator 320, an incident-end optical element group 322, a receiving-end optical element group 324, and an optical receiver 326. The light source generator 320 generates a measurement light beam Lₘ, whose wavelength lies within the optical wavelength range and covers at least from the ultraviolet band to the near-infrared band. Specifically, the light source generator 320 can produce light beams with wavelengths ranging from 200 nm to 3000 nm. In some embodiments, the light source generator 320 may include components such as titanium-doped sapphire lasers, mercury arc lamps, or halogen lamps, so as to generate measurement light beams Lₘ with various wavelengths.

The incident-end optical element group 322 is configured to guide the measurement light beam Lₘ to the sample to-be-tested SP. The incident-end optical element group 322 may include one or more optical elements. In this embodiment, the incident-end optical element group 322 may, for example, include an optical filter, an optical collimator, an optical polarizer, and an optical compensator arranged sequentially between the light source generator 320 and the sample to-be-tested SP. However, the present disclosure is not limited to this configuration. The elements of the incident-end optical element group 322 can be selected based on user requirements. The optical filter can be configured to filter out stray light outside the target detection wavelength from the measurement light beam Lₘ generated by the light source generator 320. The optical collimator can collimate the divergent light from the light source generator 320 into a symmetric and uniform measurement light beam Lₘ. The optical polarizer can be configured to filter the measurement light beam Lₘ, thereby allowing light in a specific direction to pass through and imparting polarization characteristics to the measurement light beam Lₘ. The optical compensator can transform the light beam modified by the optical polarizer into circularly polarized light or elliptically polarized light.

Similarly, the receiving-end optical element group 324 can also include one or more optical elements to receive the optical signal to-be-measured Lₘ′ generated when the measurement light beam Lₘ irradiates the sample to-be-tested SP. The receiving-end optical element group 324 may include, for example, an optical filter, an optical collimator, an optical polarizer, and an optical compensator arranged sequentially. The purposes of the optical filter and the optical collimator are the same as previously described and will not be repeated here. The optical polarizer on the receiving end can be a rotary polarizer, configured to modify the measurement light beam Lₘ after it passes through the optical compensator on the incident end into a light source with polarization characteristics. Similarly, the optical compensator on the receiving end can be a rotary compensator whose rotation can improve measurement accuracy.

The optical receiver 326 is configured to receive the optical signal to-be-measured Lₘ′ guided by the receiving-end optical element group 324 and to generate optical spectrum information corresponding to the optical signal to-be-measured Lₘ′. The optical receiver 326 may, for example, be a spectrometer that receives the optical signal to-be-measured Lₘ′ reflected or scattered from the sample to-be-tested SP.

During the measurement process, the processing device 36 can control the multi-axis sample stage 30 to move and/or rotate so that the optical receiver 326 of the optical measurement subsystem 32 can receive the plurality of optical signals to-be-measured Lₘ′ generated at the plurality of optical measurement positions and/or angles and generate the plurality of pieces of optical spectrum information corresponding to the plurality of optical signals to-be-measured Lₘ′.

Additionally, the light source generator 320 and the optical receiver 326 are mounted on the optical rotation mechanism 328. The optical rotation mechanism 328 may include one or more mechanical arms connected to the light source generator 320 and the optical receiver 326, and each mechanical arm has a plurality of degrees of freedom. This allows the light source generator 320 and the optical receiver 326 to rotate simultaneously or separately around the sample to-be-tested SP. In this configuration, while the processing device 36 controls the multi-axis sample stage 30 to move and/or rotate, it can also control the optical rotation mechanism 328 to rotate. This enables the light source generator 320 to direct the measurement light beam Lₘ from a plurality of directions and allows the optical receiver 326 to receive the plurality of optical signal to-be-measured Lₘ generated from various optical measurement angles, and to produce the plurality of pieces of optical spectrum information corresponding to the plurality of optical signals to-be-measured Lₘ′.

The X-ray measurement subsystem 34 is essentially similar to the X-ray measurement system 1. The X-ray measurement subsystem 34 includes an X-ray generator 340, an X-ray optical element group 342, and an X-ray detector 344. It is worth noting that the X-ray generator 340 uses the same configuration as the X-ray generator 12 in the first embodiment, and employs an X-ray target material with a plurality of excitation target materials embedded in a heat dissipation base material as the anode, thereby enhancing heat dissipation efficiency. Details and advantages of the X-ray generator 340 can be found in the first embodiment and will not be repeated here.

The X-ray optical element group 342 is configured to guide the measurement X-ray beam Lx to the sample to-be-tested SP. The measurement X-ray beam Lx is primarily used for X-ray analysis techniques and may, for example, have a wavelength greater than 0.1 nanometers. It can include hard X-rays, soft X-rays, or gamma rays.

When the measurement X-ray beam Lx irradiates the sample to-be-tested SP, X-ray signals to-be-measured Lx′ are generated through reflection, diffraction, scattering, or transmission, depending on the incident angle. By positioning the X-ray detector 344 appropriately, the X-ray signals to-be-measured Lx′ can be received, and the X-ray spectrum information corresponding to the X-ray signals to-be-measured Lx′ can be generated. The X-ray detector 344 can be a high-spatial-resolution detector with one or more dimensions and is capable of capturing the X-ray signals to-be-measured Lx′ with an energy greater than 1 keV.

During the measurement process, the processing device 36 can control the multi-axis sample stage 30 to move and/or rotate so that the X-ray detector 344 can receive the plurality of X-ray signals to-be-measured Lx′ generated at various optical measurement positions and/or X-ray measurement angles, and produce the plurality of pieces of X-ray spectrum information corresponding to the plurality of X-ray signals to-be-measured Lx′.

Additionally, the X-ray generator 340 and the X-ray detector 344 are mounted on the X-ray rotation mechanism 346. The X-ray rotation mechanism 346 may include one or more mechanical arms connected to the X-ray generator 340 and the X-ray detector 344, and each mechanical arm has a plurality of degrees of freedom. This allows the X-ray generator 340 and the X-ray detector 344 to rotate simultaneously or separately around the sample to-be-tested SP. In this configuration, while the processing device 36 controls the multi-axis sample stage 30 to move and/or rotate, it can also control the X-ray rotation mechanism 346 to rotate. This enables the X-ray generator 340 to direct the measurement X-ray beam Lx from a plurality of directions and allows the X-ray detector 344 to receive the plurality of X-ray signal to-be-measured Lx′ generated from various X-ray measurement angles, and to produce the plurality of pieces of X-ray spectrum information corresponding to the plurality of X-ray signal to-be-measured Lx′.

Moreover, the composite semiconductor inspection system 3 provided by the present disclosure can meet both anisotropic and isotropic measurement requirements. For instance, while the X-ray measurement subsystem 34 is conducting measurements, the optical measurement subsystem 32 can simultaneously perform measurements at a specified azimuth angle, thereby achieving simultaneous anisotropic measurements. To achieve isotropic measurement, after the X-ray measurement subsystem 34 has completed the measurement, the multi-axis sample stage 30 can rotate along the Z-axis to the corresponding azimuth angle φ, thereby enabling the sample to-be-tested SP to rotate. This allows the X-ray measurement subsystem 34 and the optical measurement subsystem 32 to measure under the same positional and spatial characteristics, thereby accurately obtaining both X-ray signals to-be-measured Lx′ and optical signals to-be-measured Lₘ′ from the same orientation and position within the same system.

The processing device 36 may, for example, be a computer system comprising a processor and memory, configured to execute stored instruction sets or programs to control the controllable components within the multi-axis sample stage 30, the optical measurement subsystem 32, and the X-ray measurement subsystem 34. Additionally, the processing device 36 can output the optical spectrum information and X-ray spectrum information as the measurement result of the sample to-be-tested SP, or further fit the optical and X-ray spectrum information to obtain the structural parameters of the sample to-be-tested SP as the measurement result. The structural parameters may include one or more of thickness, roughness, density, critical dimension, line edge roughness, refractive index, and extinction coefficient.

For example, the processing device 36 can fit the optical spectrum information and X-ray spectrum information. The optical spectrum information may include reflection spectra obtained by directing the measurement light beam Lₘ at the plurality of different incident angles onto the sample to-be-tested SP. The X-ray spectrum information may include reflection spectra obtained by directing the measurement X-ray beam Lx at the plurality of different incident angles onto the sample to-be-tested SP. The fitting results may include the structural parameters of the sample to-be-tested SP.

Specifically, the processing device 36 can fit the optical spectrum information and X-ray spectrum information to inversely reconstruct critical structural parameters of the sample to-be-tested SP.

In this embodiment, the optical spectrum information may be generated from different interaction mechanisms between the measurement light beam Lₘ and the sample to-be-tested SP. For example, the optical spectrum information may include optical reflection spectrum information and optical scattering spectrum information. The optical reflection spectrum information can be obtained by appropriately controlling the azimuthal angles θ and ¢, so as to direct the light source generator 320 to emit the measurement light beam Lₘ at the plurality of wavelengths and incident angles, and the optical receiver 326 collects the optical signal to-be-measured Lₘ′ generated by reflection. Similarly, the optical scattering spectrum information can be obtained by the optical receiver 326 collecting the optical signal to-be-measured Lₘ′ generated by scattering. In the fitting analysis program, the processing device 36 can statistically fit the optical reflection spectrum information and optical scattering spectrum information to inversely reconstruct critical structural parameters of the sample to-be-tested SP.

Similarly, the X-ray spectrum information may be generated from different interaction mechanisms between the measurement X-ray beam Lx and the sample to-be-tested SP. For example, the X-ray spectrum information may include X-ray reflection spectrum information, X-ray scattering spectrum information, X-ray diffraction spectrum information, and X-ray fluorescence spectrum information. The X-ray reflection spectrum information can be obtained by appropriately controlling the azimuthal angles θ and φ, thereby allowing the X-ray detector 344 to collect the X-ray signal to-be-measured Lx′ generated by reflection. Similarly, the X-ray scattering spectrum information, X-ray diffraction spectrum information, and X-ray fluorescence spectrum information can be obtained by the X-ray detector 344 collecting the X-ray signals to-be-measured Lx′ generated by scattering, diffraction, and fluorescence excitation, respectively. In the fitting analysis program, the processing device 36 can analyze the X-ray reflection spectrum information, X-ray scattering spectrum information, X-ray diffraction spectrum information, and X-ray fluorescence spectrum information. These analyses include X-ray reflectivity (XRR), X-ray diffraction (XRD), small-angle X-ray scattering (SAXS), and X-ray fluorescence (XRF) to inversely reconstruct critical structural parameters of the sample to-be-tested SP.

Taking XRR analysis as an example, when the measurement X-ray beam Lx is directed onto the surface of the sample to-be-tested SP, XRR analysis can determine the structural parameters of the sample to-be-tested SP. For instance, if the sample to-be-tested SP includes a multilayer structure, XRR analysis can determine the density, thickness, and roughness of each layer based on the collected X-ray reflection spectrum information. On the other hand, if the sample to-be-tested SP contains small components, such as a gate-all-around field-effect transistor (GAA-FET), XRR analysis can determine the orientation and critical dimensions of the GAA-FET based on the X-ray reflection spectrum.

### Advantages of the Embodiment

One of the advantages of the present disclosure is that the X-ray measurement system and composite semiconductor inspection system incorporate high-entropy alloy materials (HEAMs) as the anode in the X-ray target. By embedding the plurality of excitation target materials in the heat dissipation base material, a larger contact area is created between the plurality of excitation target materials and the heat dissipation base material, so as to improve heat dissipation capability. Furthermore, the use of the line focus principle allows control over the size of the X-ray beam to achieve the desired dimensions, thereby effectively mitigating the issue of electron beam damage to the anode that affects X-ray flux.

Additionally, the composite semiconductor inspection system provided by the present disclosure provides three or more relative operating modes. This simplifies the mechanical design, reduces the time required for optical path calibration, and effectively improves measurement efficiency by more than twofold.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the contemplated particular use. Alternative embodiments will become apparent to those skilled in the art to which the present disclosure pertains without departing from its spirit and scope.

What is claimed is:

1. An X-ray measurement system, comprising:
a multi-axis sample stage configured to carry a sample to-be-tested;
an X-ray generator, comprising:
an electron beam generator configured to generate an incident electron beam;
an electromagnetic lens group configured to focus the incident electron beam and simultaneously control a focal position of the incident electron beam;
an X-ray target material disposed on a target material actuating device, wherein the X-ray target material receives a focused incident electron beam at an incident angle and generates a measurement X-ray beam, the X-ray target material comprises a heat dissipation base material and a plurality of excitation target materials dispersedly embedded in the heat dissipation base material; and
a vacuum cavity configured to house the electron beam generator, the electromagnetic lens group, the target material actuating device, and the X-ray target material, wherein the vacuum cavity is provided with a window through which the measurement X-ray beam passes;
an X-ray optical element group configured to guide the measurement X-ray beam to the sample to-be-tested;
an X-ray detector configured to receive an X-ray signal to-be-measured generated when the measurement X-ray beam irradiates the sample to-be-tested and to generate X-ray spectrum information corresponding to the X-ray signal to-be-measured; and
a processing device configured to output a measurement result of the sample to-be-tested based on the X-ray spectrum information.

2. The X-ray measurement system according to claim 1, wherein when the X-ray target material receives the focused incident electron beam and generates the measurement X-ray beam, the target material actuating device drives the X-ray target material such that an incident position of the incident electron beam on the X-ray target material changes over time.

3. The X-ray measurement system according to claim 2, wherein the heat dissipation base material is a plate and the plurality of excitation target materials are arranged as a plurality of ring bodies sequentially from an inside to an outside around a center of the plate.

4. The X-ray measurement system according to claim 3, wherein each of the plurality of ring bodies has a rectangular cross-section and each of the plurality of ring bodies includes a light-receiving surface that does not contact the plate.

5. The X-ray measurement system according to claim 3, wherein each of the plurality of ring bodies has a triangular cross-section, the triangular cross-section has an inclined edge, the inclined edge is inclined at a predetermined angle relative to the first surface of the plate, and the predetermined angles of the plurality of ring bodies are different from each other.

6. The X-ray measurement system according to claim 5, wherein the predetermined angles of the plurality ring bodies increase progressively outward from the center of the plate.

7. The X-ray measurement system according to claim 3, wherein the plate is a bowl-shaped plate, each of the plurality of ring bodies is arranged around a central bottom portion of the bowl-shaped plate, and each of the plurality of ring bodies includes a light-receiving surface that does not contact the bowl-shaped plate.

8. The X-ray measurement system according to claim 2, wherein the heat dissipation base material is a plate, the plurality of excitation target materials are a plurality of blocks arranged in an array on a first surface of the plate, and of each of the plurality of blocks block has a light-receiving surface that does not contact the plate.

9. The X-ray measurement system according to claim 3, wherein an area of an electron beam cross-section formed by the incident electron beam irradiating the X-ray target material is smaller than an area of a first surface of the plate.

10. A composite semiconductor inspection system, comprising:
a multi-axis sample stage configured to carry a sample to-be-tested;
at least two X-ray measurement subsystems, each comprising:
an X-ray generator, comprising:
an electron beam generator configured to generate an incident electron beam;
an electromagnetic lens group configured to focus an incident electron beam and simultaneously control a focal position of the incident electron beam;
an X-ray target material disposed on a target material actuating device, wherein the X-ray target material receives a focused incident electron beam at an incident angle and generates a measurement X-ray beam, the X-ray target material comprises a heat dissipation base material and a plurality of excitation target materials dispersedly embedded in the heat dissipation base material; and
a vacuum cavity configured to house the electron beam generator, the electromagnetic lens group, the target material actuating device, and the X-ray target material, wherein the vacuum cavity is provided with a window through which the measurement X-ray beam passes;
an X-ray optical element group configured to guide the measurement X-ray beam to the sample to-be-tested;
an X-ray detector configured to receive an X-ray signal to-be-measured generated when the measurement X-ray beam irradiates the sample to-be-tested and to generate X-ray spectrum information corresponding to the X-ray signal to-be-measured; and
a processing device configured to output a measurement result of the sample to-be-tested based on the X-ray spectrum information generated by at least the two X-ray measurement subsystems.

11. The composite semiconductor inspection system according to claim 10, wherein when the X-ray target material receives the focused incident electron beam and generates the measurement X-ray beam, the target material actuating device drives the X-ray target material such that an incident position of the incident electron beam on the X-ray target material changes over time.

12. The composite semiconductor inspection system according to claim 11, wherein the heat dissipation base material is a plate and the plurality of excitation target materials are arranged as a plurality of ring bodies sequentially from an inside to an outside around a center of the plate.

13. The composite semiconductor inspection system according to claim 12, wherein each of the plurality of ring bodies has a rectangular cross-section and each of the plurality of ring bodies includes a light-receiving surface that does not contact the plate.

14. The composite semiconductor inspection system according to claim 12, wherein each of the plurality of ring bodies has a triangular cross-section, the triangular cross-section has an inclined edge, the inclined edge is inclined at a predetermined angle relative to a first surface of the plate, and the predetermined angles of the plurality of ring bodies are different from each other.

15. The composite semiconductor inspection system according to claim 14, wherein the predetermined angles of the plurality ring bodies increase progressively outward from the center of the plate.

16. The composite semiconductor inspection system according to claim 12, wherein the plate is a bowl-shaped plate, each of the plurality ring bodies is arranged around a central bottom portion of the bowl-shaped plate, and each of the plurality ring bodies includes a light-receiving surface that does not contact the bowl-shaped plate.

17. The composite semiconductor inspection system according to claim 11, wherein the heat dissipation base material is a plate, the plurality of excitation target materials are a plurality of blocks arranged in an array on a first surface of the plate, and each of the plurality of blocks has a light-receiving surface that does not contact the plate.

18. The composite semiconductor inspection system according to claim 12, wherein an area of an electron beam cross-section formed by the incident electron beam irradiating the X-ray target material is smaller than an area of a first surface of the plate.

19. The composite semiconductor inspection system according to claim 10, wherein the multi-axis sample stage includes a stage movement mechanism and a stage rotation mechanism, the stage movement mechanism is configured to move the sample to-be-tested along one or more of a first axis, a second axis, and a third axis, and the stage rotation mechanism is configured to rotate the sample to-be-tested around one or more of the first axis, the second axis, and the third axis, and wherein the X-ray detector of each of the at least two X-ray measurement subsystems is disposed on an X-ray rotation mechanism to enable the X-ray detector to rotate simultaneously or separately around the sample to-be-tested;
wherein the processing device is further configured to control the multi-axis sample stage to move and/or rotate and to control each X-ray rotation mechanism to rotate, so as to enable the X-ray detector of each of the at least two X-ray measurement subsystems to receive the plurality of X-ray signal to-be-measured and to generate a plurality of pieces of X-ray spectrum information corresponding to a plurality of X-ray signals to-be-measured.

20. The composite semiconductor inspection system according to claim 10, wherein the multi-axis sample stage includes a stage movement mechanism and a stage rotation mechanism, the stage movement mechanism is configured to move the sample to-be-tested along one or more of a first axis, a second axis, and a third axis, and the stage rotation mechanism is configured to rotate the sample to-be-tested around one or more of the first axis, the second axis, and the third axis, and wherein each X-ray generator of the X-ray measurement subsystems is disposed on an X-ray rotation mechanism to enable the X-ray generator to rotate simultaneously or separately around the sample to-be-tested;
wherein the processing device is further configured to control the multi-axis sample stage to move and/or rotate and to control each X-ray rotation mechanism to rotate, so as to enable the X-ray detector of each of the at least two X-ray measurement subsystems to receive the plurality of X-ray signal to-be-measured and to generate the plurality of pieces of X-ray spectrum information corresponding to the plurality of X-ray signals to-be-measured.

21. The composite semiconductor inspection system according to claim 10, wherein the X-ray generator and the X-ray detector of each of the at least two X-ray measurement subsystems are disposed on the X-ray rotation mechanism to enable the X-ray generator and the X-ray detector to rotate simultaneously or separately around the sample to-be-tested;
wherein the processing device is further configured to control each X-ray rotation mechanism to rotate, so as to enable the X-ray detector of each of the at least two X-ray measurement subsystems to receive the plurality of X-ray signal to-be-measured and to generate the plurality of pieces of X-ray spectrum information corresponding to the X-ray signals to-be-measured.

22. A composite semiconductor inspection system, comprising:
a multi-axis sample stage configured to carry a sample to-be-tested;
an optical measurement subsystem, comprising:
a light source generator configured to generate a measurement light beam with a wavelength within an optical wavelength range, the optical wavelength range at least covering an ultraviolet light band to a near-infrared light band;
an incident-end optical element group configured to guide the measurement light beam to a sample to-be-tested;
a receiving-end optical element group configured to receive an optical signal to-be-measured generated when the measurement light beam irradiates the sample to-be-tested; and
an optical receiver configured to receive the optical signal to-be-measured guided by the receiving-end optical element group and to generate optical spectrum information corresponding to the optical signal to-be-measured;
an X-ray measurement subsystem, comprising:
an X-ray generator according to claim 1;
an X-ray optical element group configured to guide the measurement X-ray beam to the sample to-be-tested; and
an X-ray detector configured to receive an X-ray signal to-be-measured generated when the measurement X-ray beam irradiates the sample to-be-tested and to generate X-ray spectrum information corresponding to the X-ray signal to-be-measured; and
a processing device configured to output a measurement result of the sample to-be-tested based on the optical spectrum information and the X-ray spectrum information.
